(19) United States
(12) Patent Application Publication
(10) Pub. No.: US 2018/0119927 A1
(43) Pub. Date: May 3, 2018

(54) Changeable Shade Display System

(71) Applicant: Mike Lynn Warren, II, Perryville, MO (US)

(72) Inventor: Mike Lynn Warren, II, Perryville, MO (US)

(21) Appl. No.: 15/801,207

(22) Filed: Nov. 1, 2017

Related U.S. Application Data
(60) Provisional application No. 62/415,655, filed on Nov. 1, 2016.

(51) Int. Cl. F21V 17/00; G09F 13/04; F21V 1/08

(52) U.S. Cl. CPC F21V 17/002; G09F 23/06; F21V 1/08; G09F 13/0413

(57) ABSTRACT

The changeable shade display system is a way to hang or attach a changeable cylindrical shade or decorative elements to market, advertise or enhance the décor of an interior or exterior space.

### CROSS-REFERENCE TO RELATED APPLICATIONS

I'm claiming the benefit of an earlier filed provisional application. Please refer to application No. 62/415,655 filed on Nov. 1, 2016.

### BACKGROUND OF THE INVENTION

This idea started when I was eating in a restaurant and as I was looking around the restaurant and I realized that most of the tables had pendant lights hanging above them right in clear view of everyone in the restaurant . . . how cool would it be if you could have custom designed light shades that were on the pendant lights that could fit the needs of that space? Then I thought how cool would it be If you could change those pendant light shades easily, changing the look of the space, the mood and influence customers buying decisions by what your pendant light shades have on them? Then I thought why would it have to be limited to pendant lights . . . . I could come up with a way to attach a shade that could hang or be attached to something and make it so the shade part could be changed out easily. I started making prototypes with different types of materials to fit different applications and had many trials and errors. I fabricated prototypes to show different ways/possibilities for different applications on how to build the changeable shade/display.

### BRIEF SUMMARY OF THE INVENTION

The changeable shade display system can be attached to existing pendant light fixtures, new pendant lights, hang it from the ceiling, attached it to a pole or a number of applications and you get a shade holder that accepts a changeable shades that can be completely customized to change the look and feel of a space. It creates a solution for designers, marketers, advertisers and individuals to customize and display graphics, cut outs, designs, photos, marketing and advertising materials and have the flexibility to change them easily. The changeable shade display system allows businesses and organizations to display marketing/advertising/decor materials directly in the consumer's line of sight.

### BRIEF DESCRIPTION OF DRAWINGS—CHANGEABLE SHADE DISPLAY SYSTEM

FIG. 1—Drawing that show hub, rods, shade (show shade flat too)

FIG. 1A—Radiating arms from center hub

FIG. 1B—Center hub

FIG. 1C—Formed cylinder

FIG. 1D—Formed cylinder rolled into itself attaching it's front edge to the back opposite edge

FIG. 1E—Holes in formed cylinder at a determined distance to align and accept radiating rods to hold cylinder

FIG. 2—Drawing that shows a ring that has tabs around it that the shade mounts to.

FIG. 2A—Tabs or pins radiating from a ring

FIG. 2B—Ring

FIG. 2C—Formed cylinder

FIG. 2D—Formed cylinder rolled into itself attaching it's front edge to the back opposite edge

FIG. 2E—Holes in formed cylinder at a determined distance to align and accept radiating tabs or pins to hold cylinder

FIG. 3—Drawing that shows hub, rods, and multiple decorative shades/items

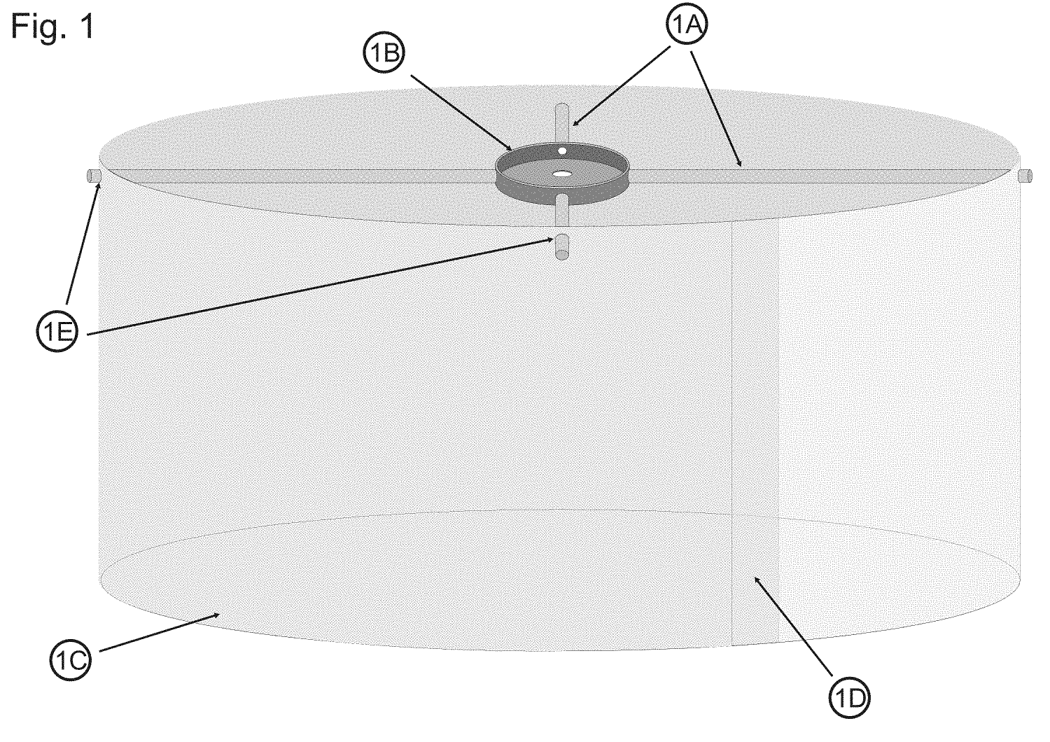

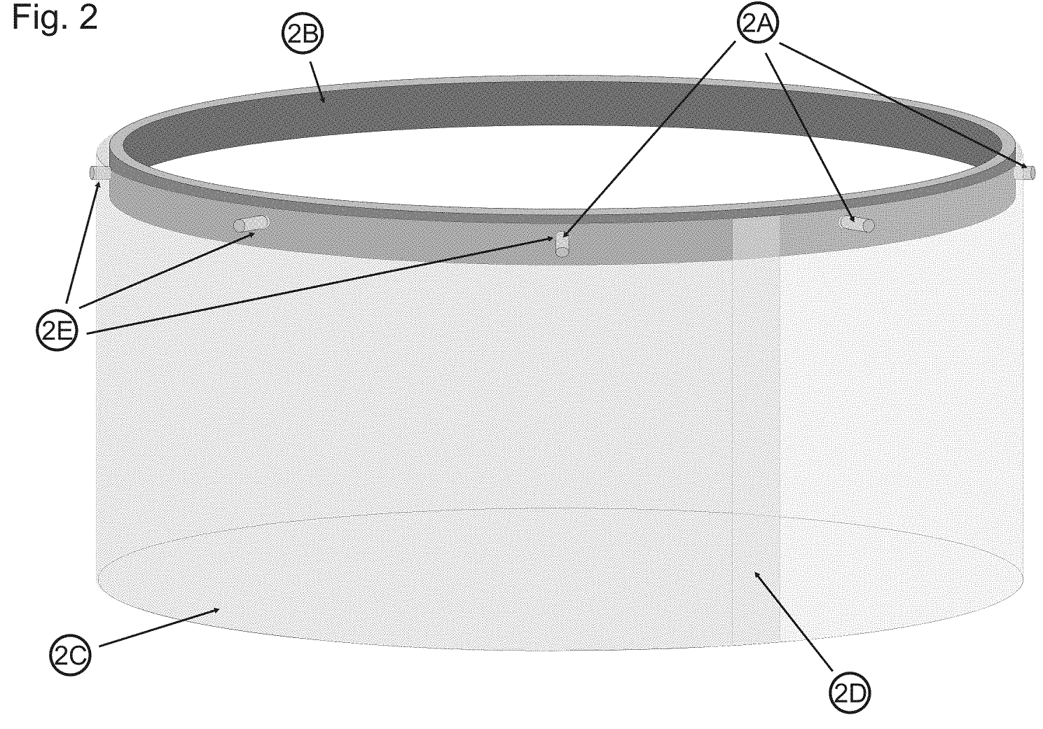

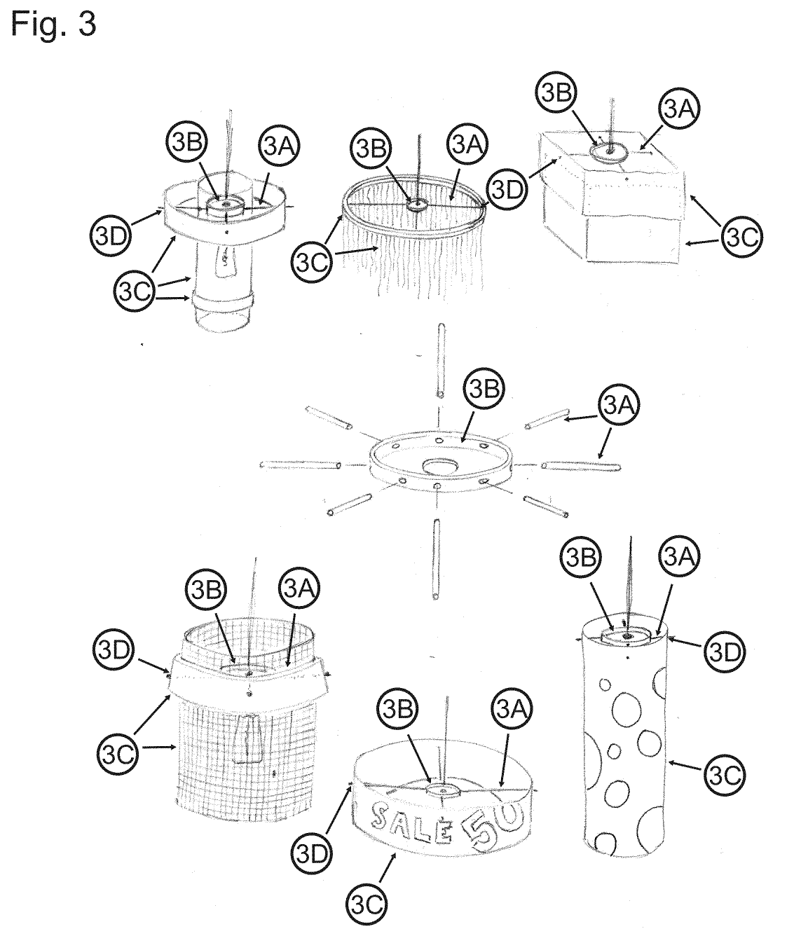

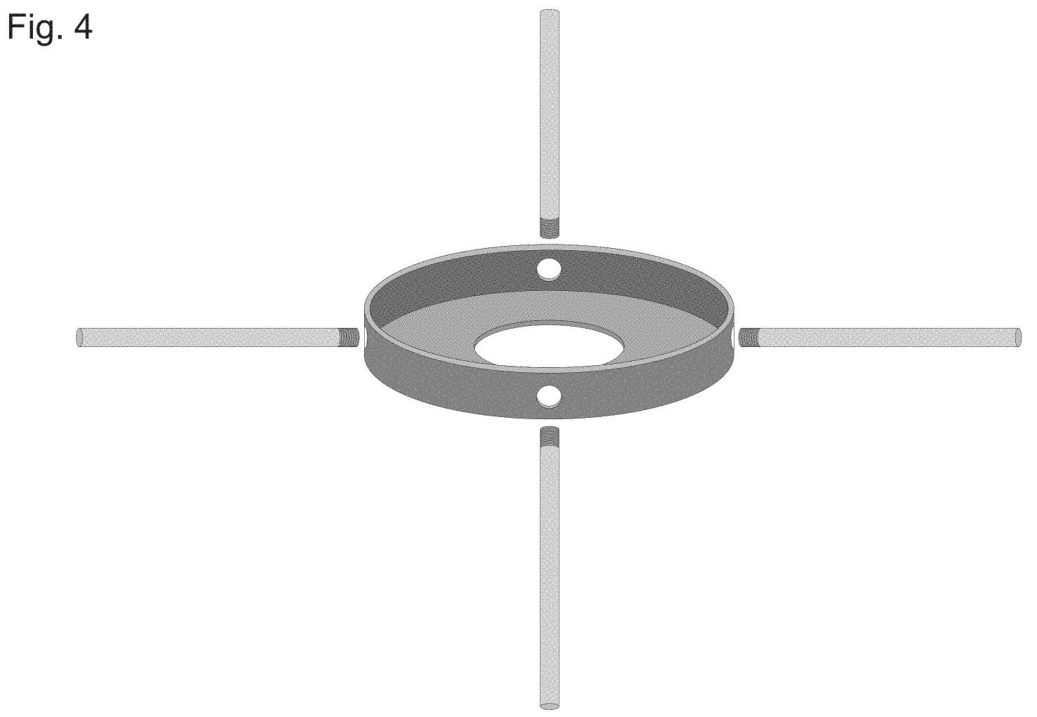

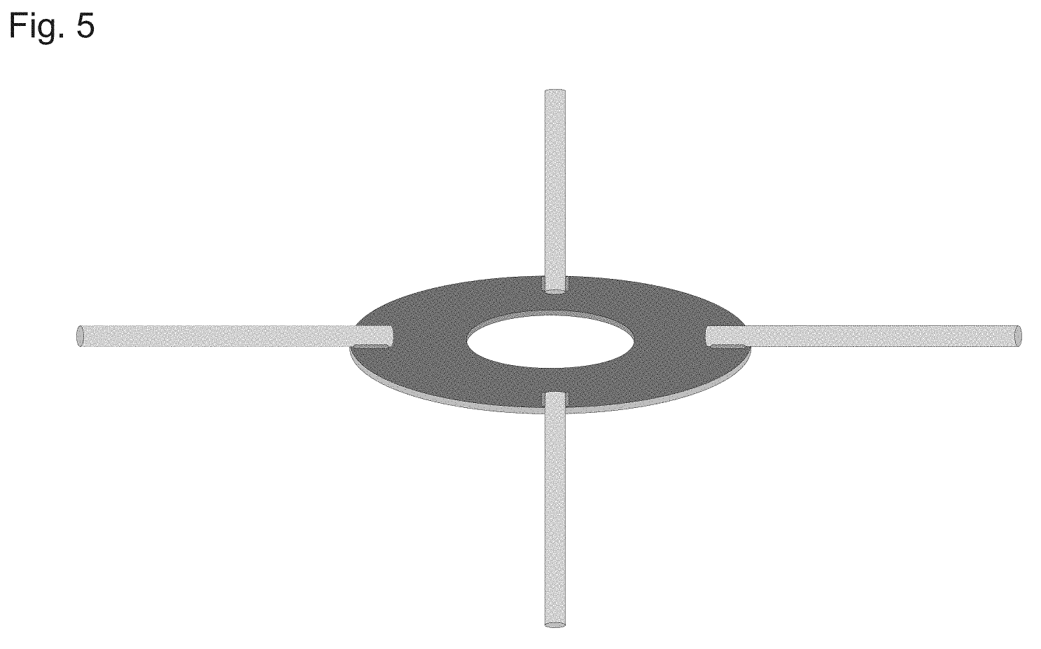

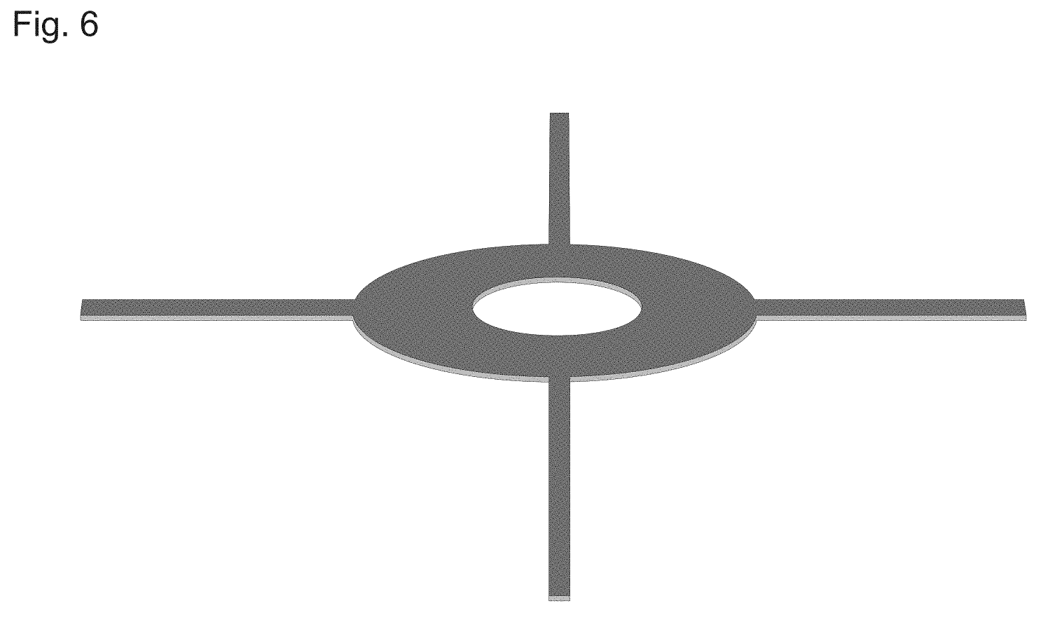

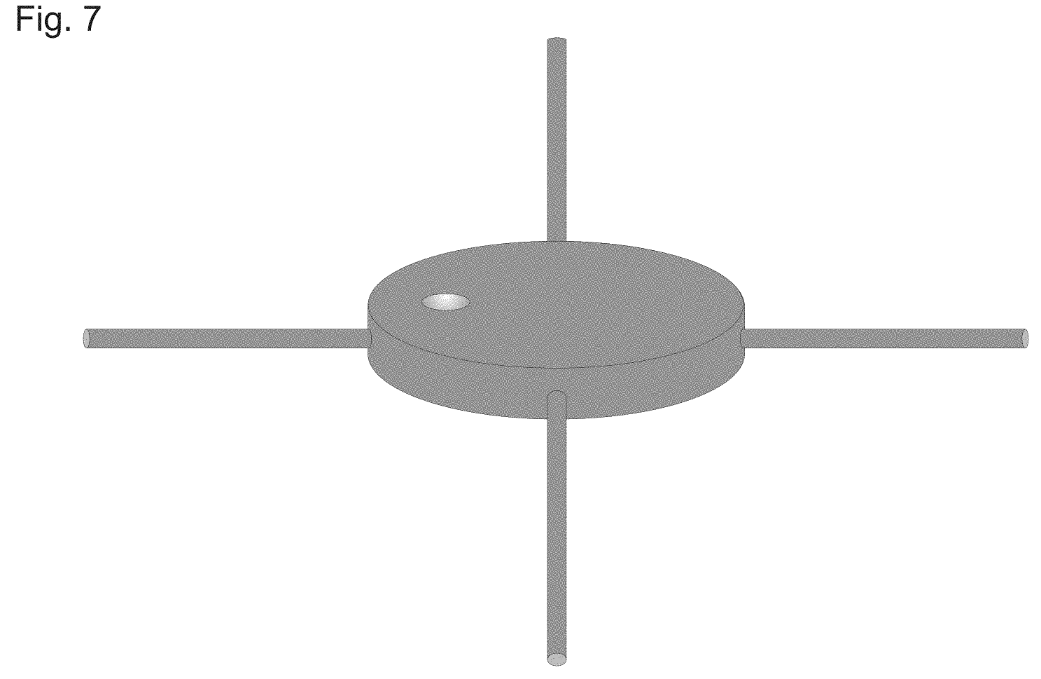

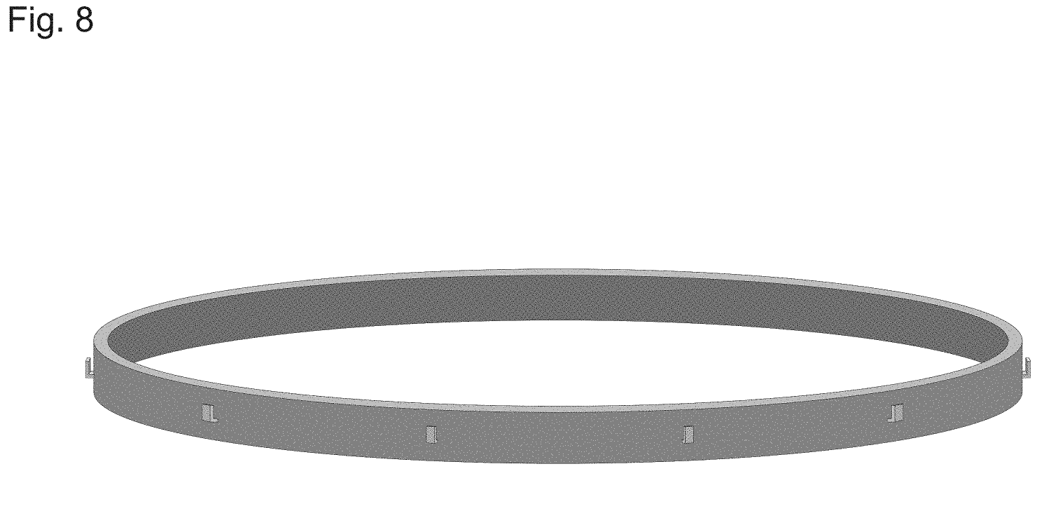

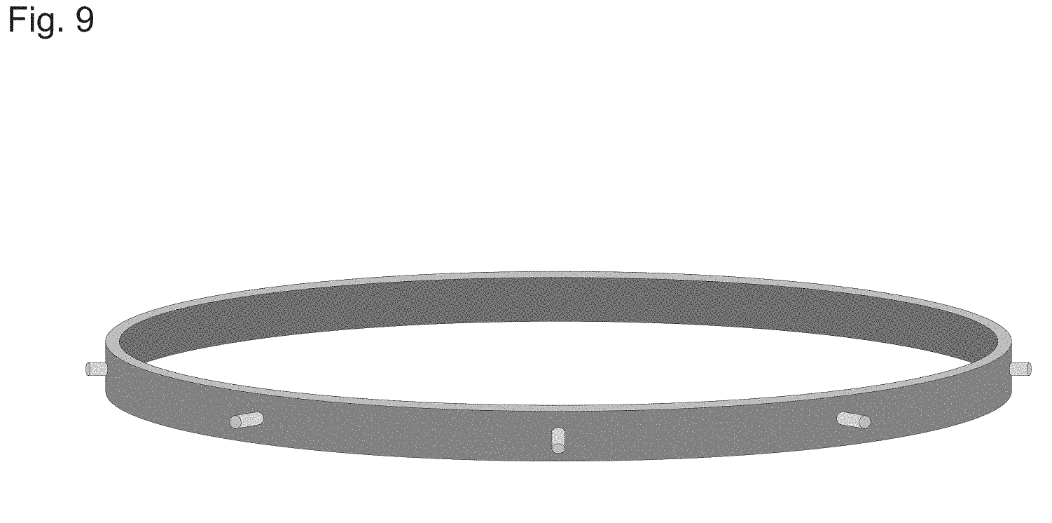

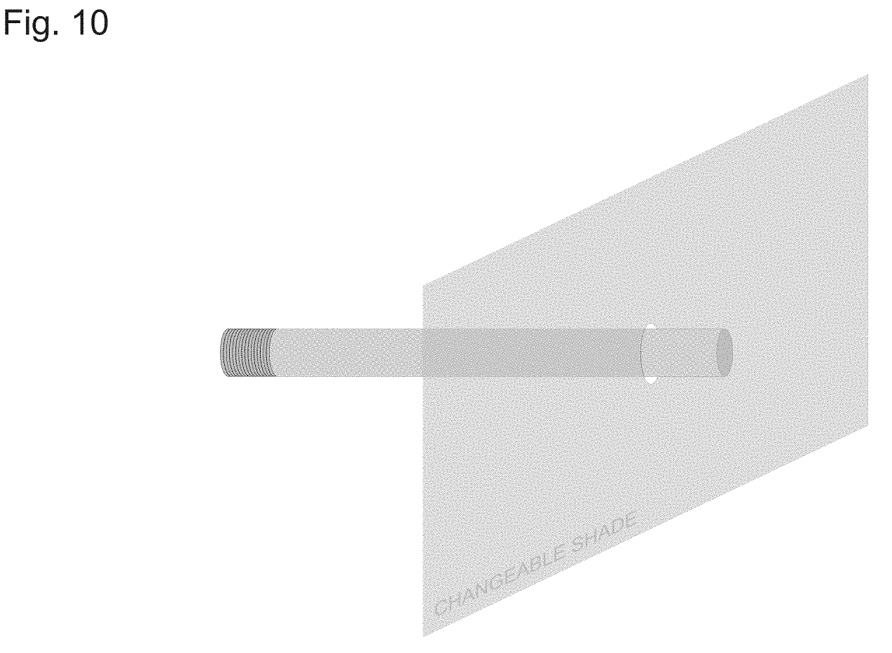

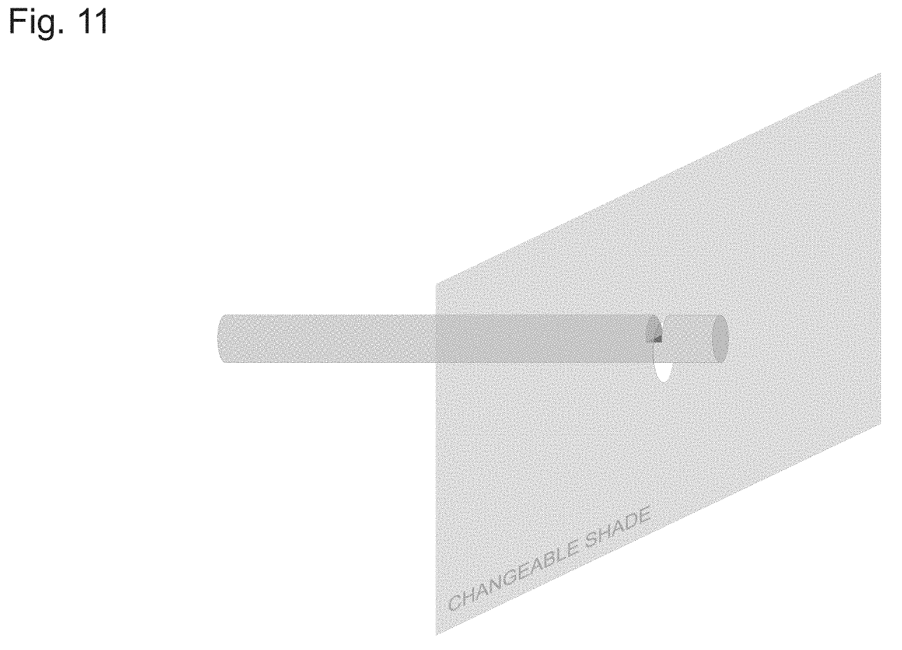

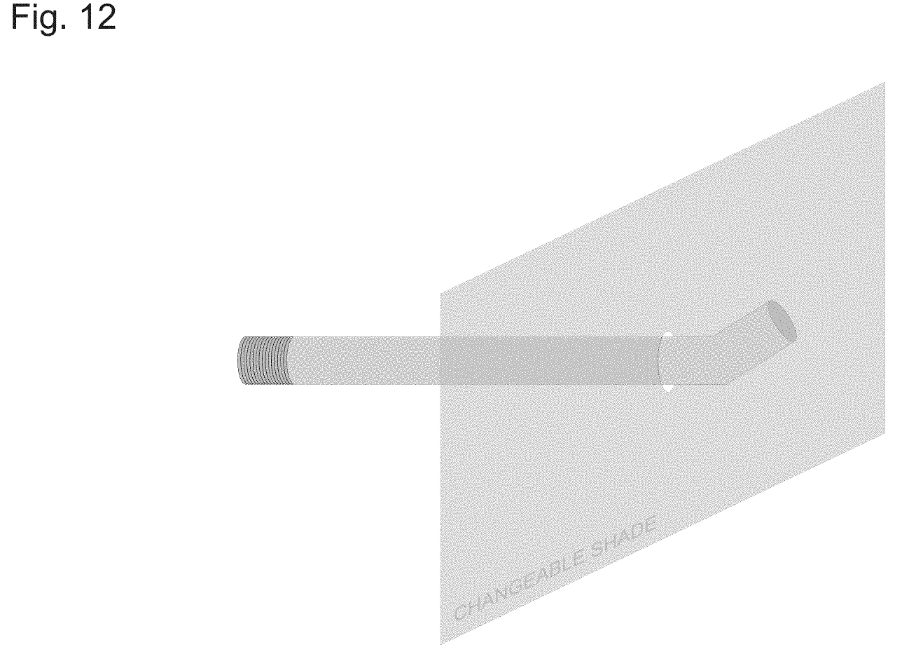

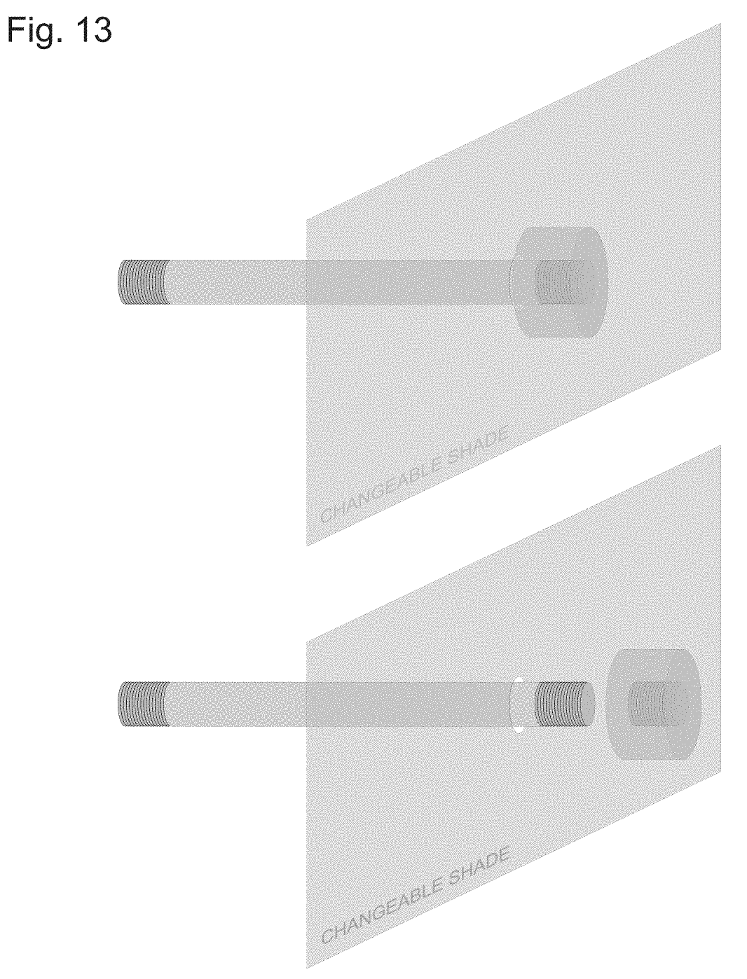

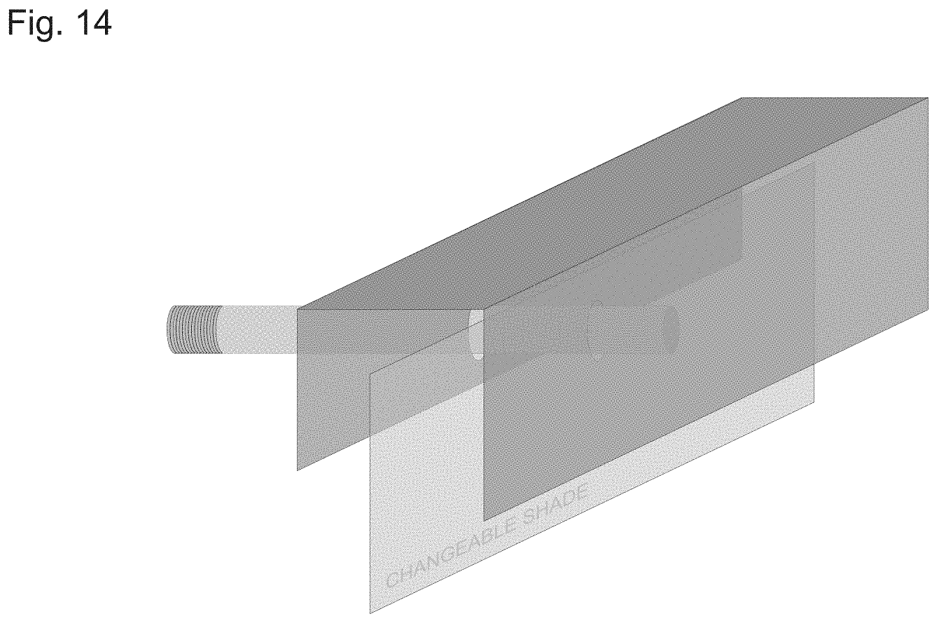

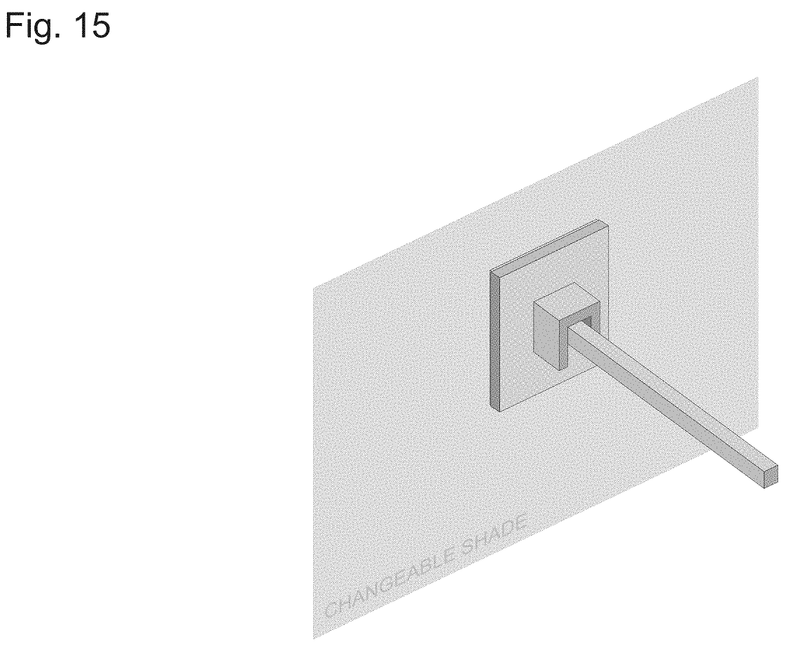

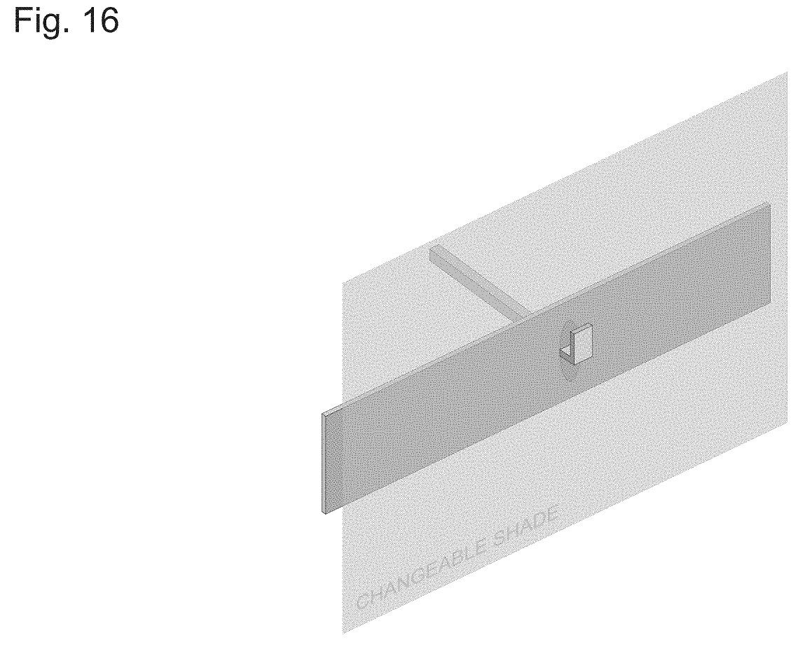

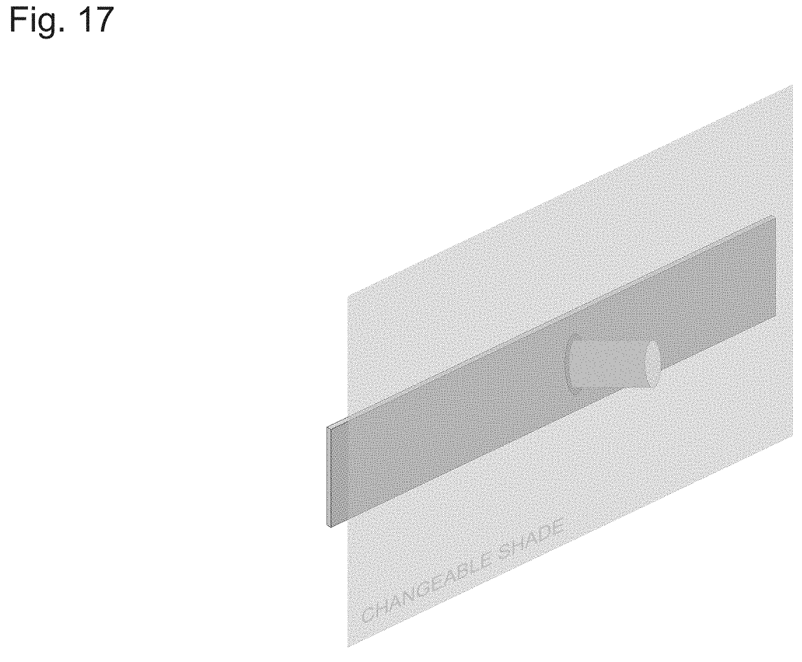

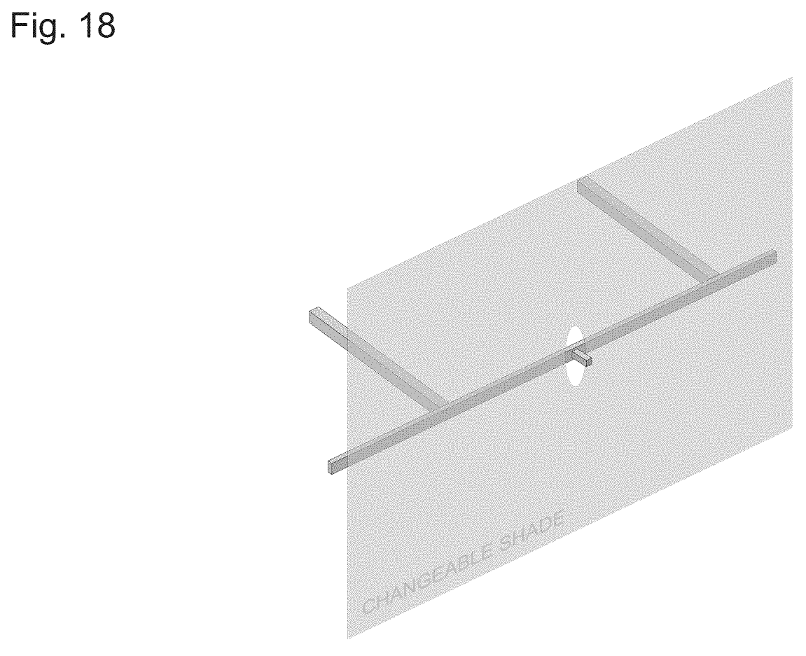

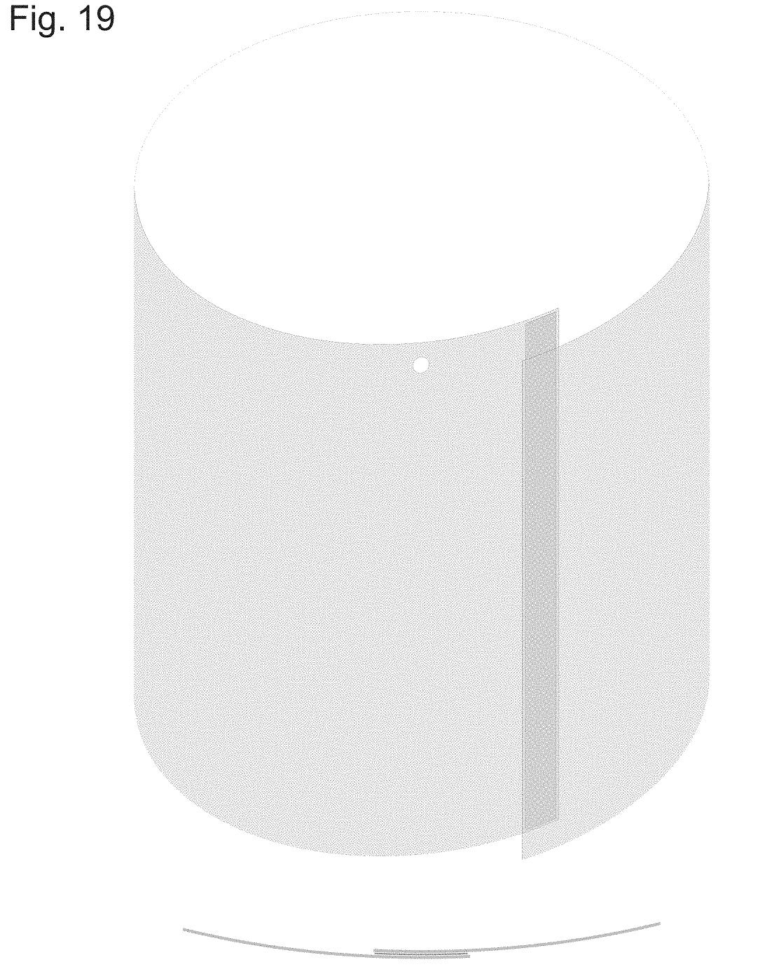

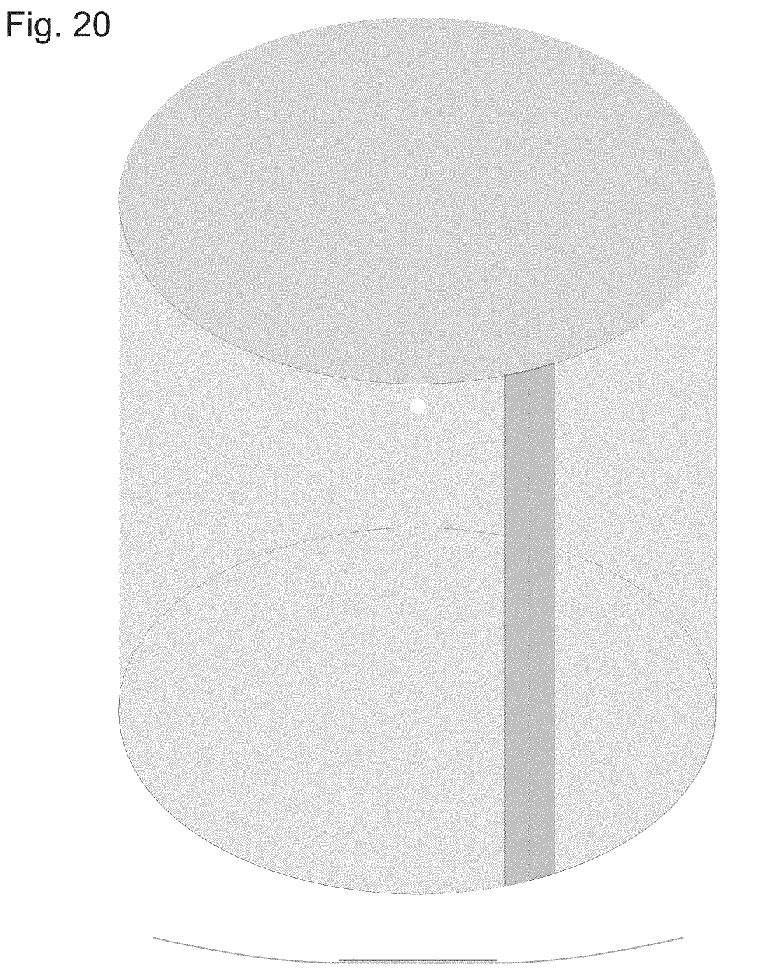

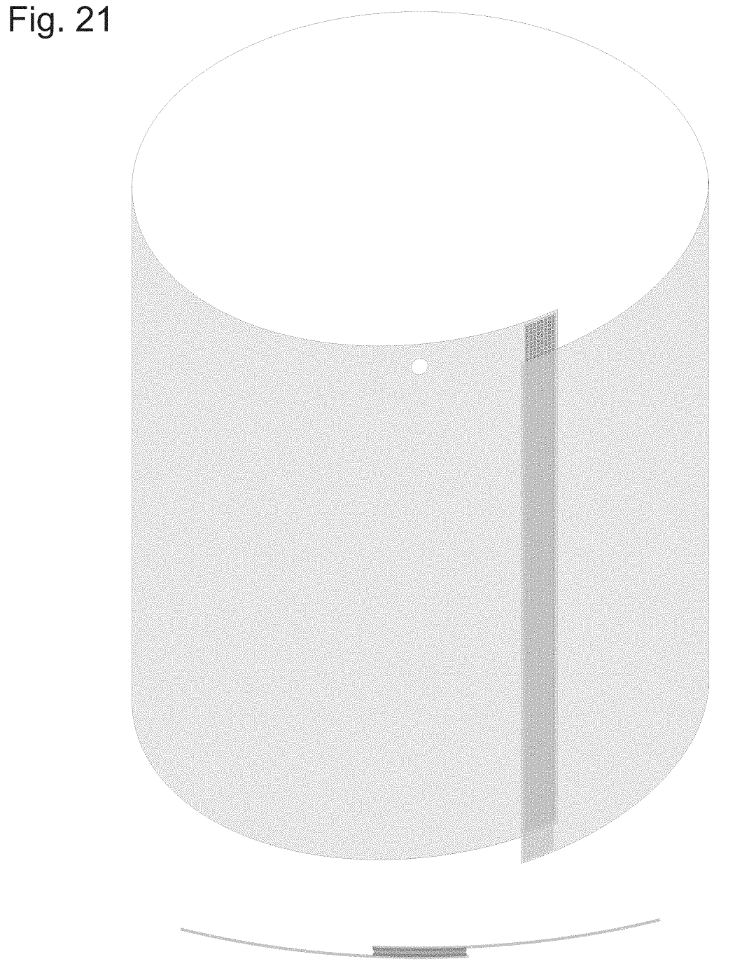

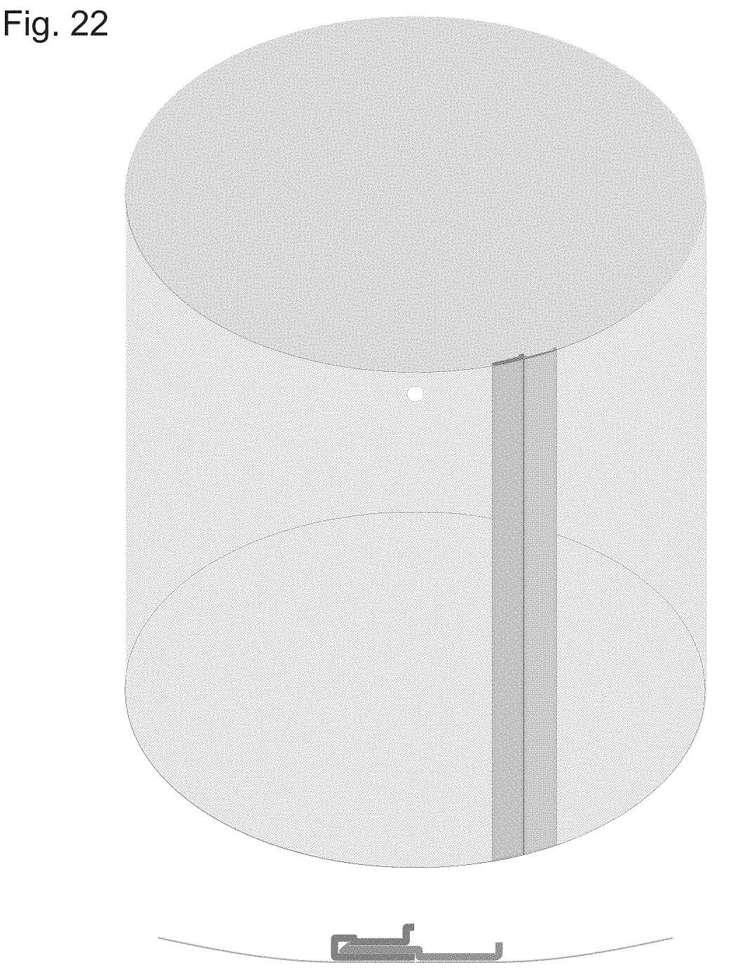

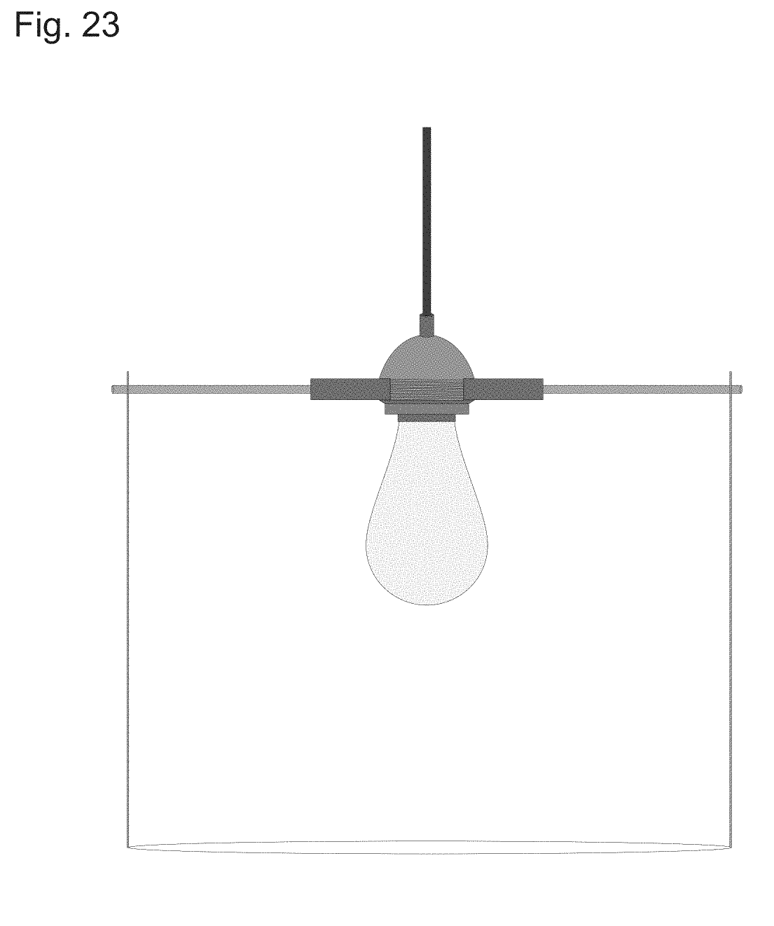

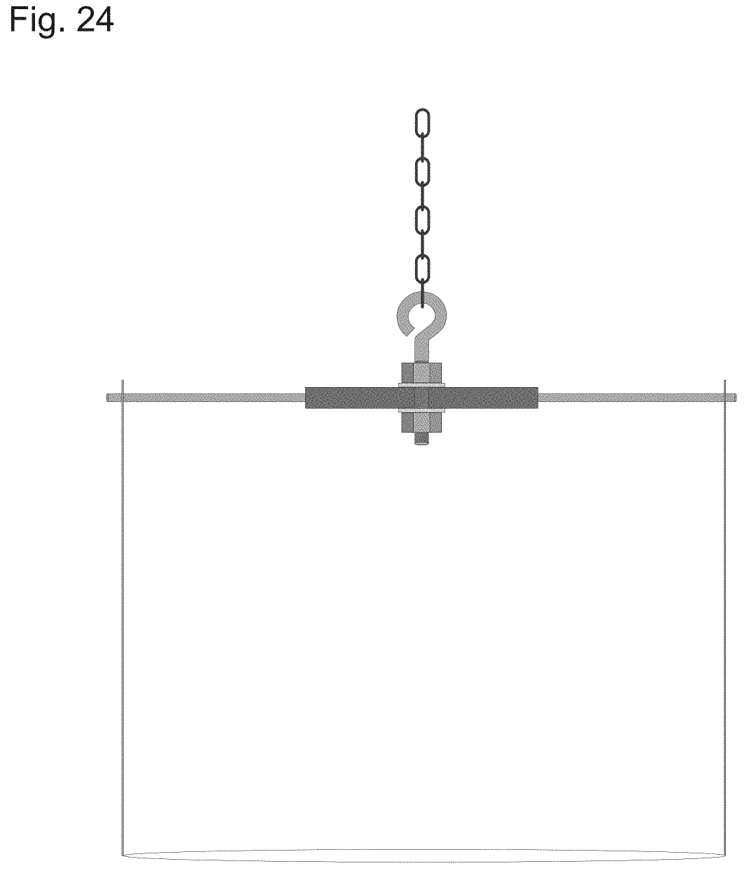

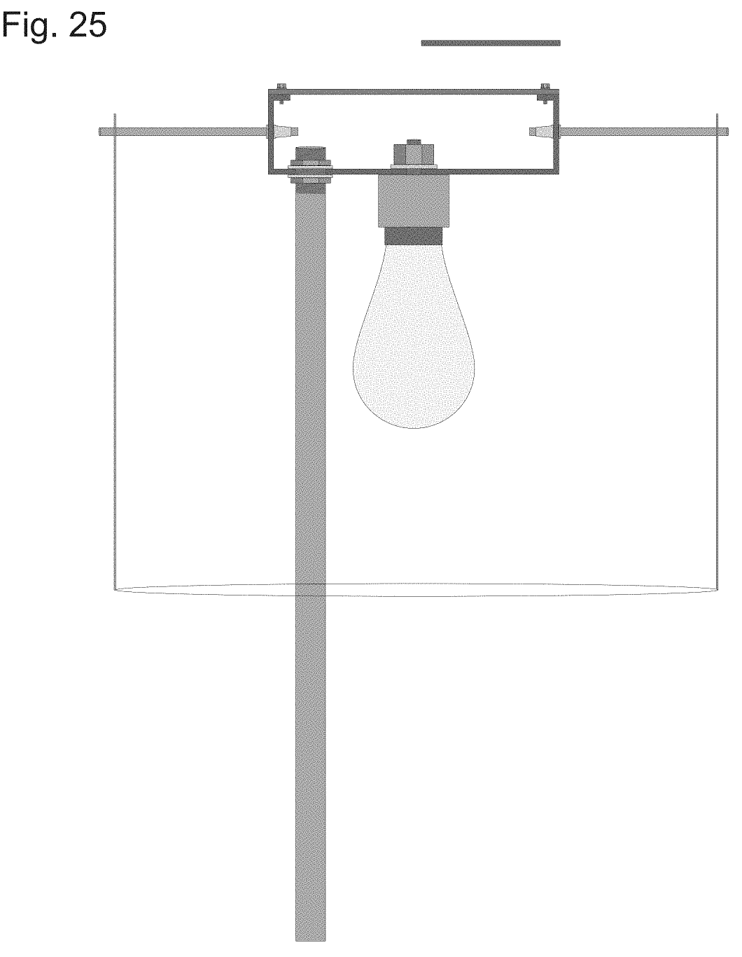

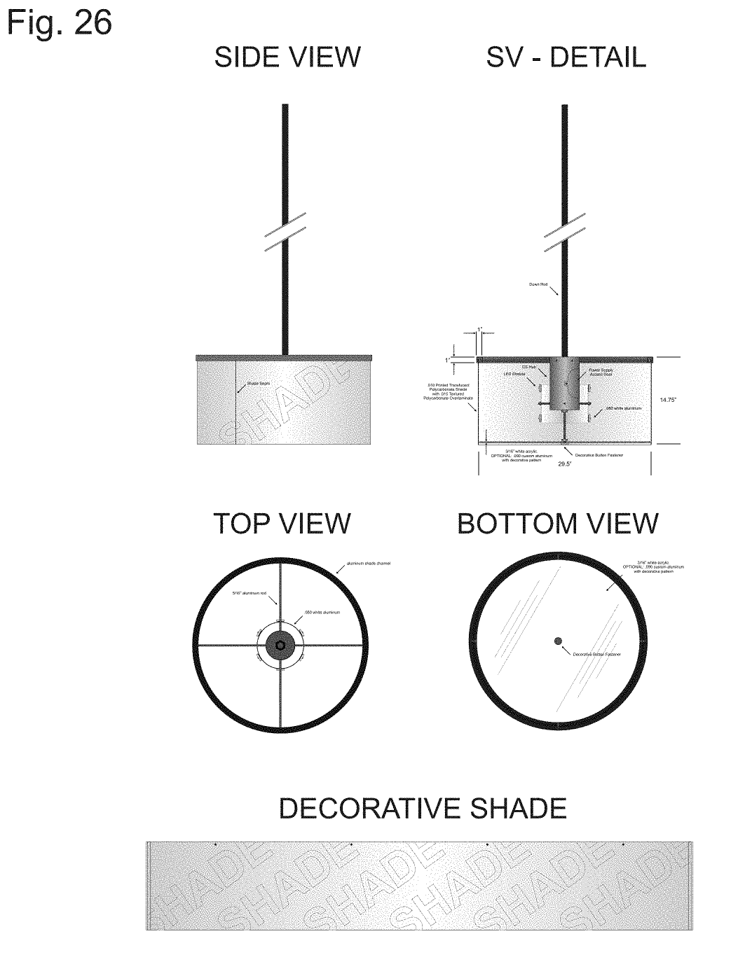

FIG. 2A—Radiating arms from center hub

FIG. 2B—Center hub

FIG. 2C—Decorative elements

FIG. 2D—Holes in decorative elements at a determined distance to align and accept radiating rods to decorative elements

Changeable shade display system hub options, comprising of but not limited to;

FIG. 4—Radiating rods with threaded ends that thread into center hub

FIG. 5—Radiating rods welded to flat disc center hub

FIG. 6—One piece radiating rods and center hub cut from flat sheet stock material

FIG. 7—Radiating rods pressed into thick disc center hub

FIG. 8—Radiating tabs from ring

FIG. 9—Radiating pins from ring

Changeable shade display system shade hanging methods, comprising of but not limited to;

FIG. 10—Cylinder with holes to align and accept radiating rod; straight rod

FIG. 11—Cylinder with holes to align and accept radiating rod; straight rod with notch

FIG. 12—Cylinder with holes to align and accept radiating rod; rod with bent end

FIG. 13—Cylinder with holes to align and accept radiating rod; rod with threaded end and threaded cap

FIG. 14—Cylinder with holes to align and accept radiating rod; straight rod with trim ring that goes over rod and cylinder

FIG. 15—Tab attached to inside of cylinder to accept radiating rod

FIG. 16—Cylinder with holes to align and accept radiating tab; tab radiating from ring

FIG. 17—Cylinder with holes to align and accept radiating pin; pin radiating from

FIG. 18—Cylinder with holes to align and accept small radiating pin; small pin radiating from

Changeable shade display system shade connecting options, comprising of but not limited to;

FIG. 19—Cylinder formed from bendable material rolled into itself attaching the front end to the back opposite end with double sided tape forming a cylinder able to hold its shape by its own means

FIG. 20—Cylinder formed from bendable material rolled into itself attaching the front end to the back opposite end with double sided tape and a thin piece of bendable material to align front end and back opposite end forming a cylinder able to hold its shape by its own means

FIG. 21—Cylinder formed from bendable material rolled into itself attaching the front end to the back opposite end with hook and loop Velcro type material forming a cylinder able to hold its shape by its own means

FIG. 22—Cylinder formed from bendable material rolled into itself attaching the front end to the back opposite end with a two piece extrusion one for the front end and one for the back end that allows for both ends to snap together forming a cylinder able to hold its shape by its own means

Changeable shade display system hanging methods, comprising of but not limited to;

FIG. 23—changeable shade display system attached to a pendant light fixture

FIG. 24—Changeable shade display system hanging from a chain by means of a hook

FIG. 25—Changeable shade display system attached to an up rod

FIG. 26—Changeable shade display system hanging from a down rod

### DETAILED DESCRIPTION OF THE INVENTION

The changeable shade display system is built starting with a center “hub” that is meant to hang from the ceiling or sit on top of or attached to a rod or pole and has rods that are equally spaced around the perimeter of the hub that radiate outward or pins or tabs that are equally spaced around the perimeter of a ring. The second part is a cylindrical shade or decorative elements. The cylindrical shade is made by taking a rectangular piece of flat bendable material that is rolled into itself and attached from the front of one end to the back of the opposite end. This rectangle piece when rolled into itself will hold it shape by its own means. This rectangular piece of material has holes punched in it that are space so that when the piece is rolled into itself to form a cylinder the holes align with the rods, pins or tabs that are radiating from the center hub or ring. The cylinder ends are attached by means that would allow it to detach from itself and be easily removed from the rods, pins or tabs and be replaced with a new cylinder. The decorative elements comprise of many different materials and are attached to the rods, pins or tabs to customize or enhance the look of the changeable shade display.

1: An apparatus, comprising: a plurality of arms radiating from a center hub; a formed cylinder; said cylinder formed of bendable material rolled into itself attaching the front end to the back opposite end forming a cylinder able to hold its shape by its own means; said cylinder has holes at a determined distance to align and accept said radiating rods holding said cylinder, wherein said cylinder can easily be removed and changed.

2: An apparatus, comprising: a plurality of tabs or pins radiating from a ring; a formed cylinder; said cylinder formed from of bendable material rolled into itself attaching the front end to the back opposite end forming a cylinder able to hold its shape by its own means; said cylinder has holes at a determined distance to align and accept said radiating tabs or pins holding said cylinder, wherein said cylinder can easily be removed and changed.

3: An apparatus, comprising: a plurality of arms radiating from a center hub; one or more decorative elements; including but not limited to cylinders, rings, square tubes, rectangular tubes, disks, circles, globes; said decorative elements have holes at a determined distance to align and accept said radiating rods holding said decorative elements, wherein said decorative elements can easily be removed and changed.
